(19) United States
(12) Patent Application Publication
(10) Pub. No.: US 2021/0372570 A1
(43) Pub. Date: Dec. 2, 2021

(54) Cryogenic storage system

(71) Applicant: MAGNA STEYR Fahrzeugtechnik AG & Co KG, Graz (AT)

(72) Inventor: Martin STUBENRAUCH, Wundschuh (AT)

(21) Appl. No.: 17/307,065

(22) Filed: May 4, 2021

(30) Foreign Application Priority Data
May 28, 2020 (DE) DE102020206689.2

(51) Int. Cl. F17C 7/02; F17C 13/04

(52) U.S. Cl. CPC F17C 7/02; F17C 13/04; F17C 2223/033; F17C 2227/0306; F17C 2225/0123; F17C 2227/039; F17C 2223/0161

(57) ABSTRACT

A storage system for storing a cryogenic medium, the storage system including a storage container for receiving the cryogenic medium. A gas removal line is configured to remove gaseous cryogenic medium from the storage container. A first heat exchanger is fluidically connected to the gas removal line and arranged outside of the storage container to heating the cryogenic medium. A second or in-tank heat exchanger is fluidically connected to the gas removal line and arranged downstream of the first heat exchanger and inside the storage container to heat liquid cryogenic medium in the storage container. A liquid removal line is configured to remove the liquid cryogenic medium from the storage container. A controllable first shut-off valve is arranged in the gas removal line, and a controllable second shut-off valve is arranged in the liquid removal line.

### CROSS-REFERENCE TO RELATED APPLICATIONS

The present application claims priority 35 U.S.C. § 119 to German Patent Application No. DE 102020206689.2 (filed on May 28, 2020), which is hereby incorporated by reference in its entirety.

### TECHNICAL FIELD

One or more embodiments relate to a storage system for storing a cryogenic medium such as, for example, hydrogen.

### BACKGROUND

It is known that cryogenic media, i.e., refrigerated and at least partially liquid media, such as hydrogen, can be kept in a storage container in order to transport energy, for example for driving a vehicle, an aircraft or a rocket. The medium is usually present in the storage container partially in liquid form and partially also in gas form.

For removing the medium from the storage container it is known to heat the removed medium outside the storage container and to feed a partial stream of the heated medium back into the storage container again, so that the medium around the returned partial stream is likewise heated in the container and therefore vaporized. By controlling or regulating the heated partial stream that is branched off, the resulting vaporization in the storage container can be controlled and the internal pressure in the storage container can accordingly be adjusted.

For example, German Patent Publication No. DE 43 20 556 A1 discloses a storage container for cryogenic media, in particular a motor vehicle storage container for liquid hydrogen, a vaporizer pipe which has an inflow line and an outflow line which lead out of the storage container being arranged in the interior of the storage container. The liquid and/or gaseous hydrogen which is removed from the storage container is thereby vaporized and heated up, and a partial stream of the vaporized and heated hydrogen is directed through the vaporizer pipe in the interior of the storage container and subsequently fed to the consumer, for example an engine or a fuel cell of the motor vehicle, together with the partial stream of the vaporized and heated hydrogen that is not directed through the vaporizer pipe.

### SUMMARY

One or more embodiments disclosed herein is to specify a storage system for storing a cryogenic medium which facilitates control of the internal pressure of a storage container of the storage system upon removal of the medium, and which is of simple construction and can be produced inexpensively.

In accordance with one or more embodiments, a storage system for storing a cryogenic medium such as hydrogen, comprises: a storage container for receiving the cryogenic medium; a gas removal line for removing the gaseous medium from the storage container; a first or external heat exchanger, fluidically connected to the gas removal line and arranged outside of the storage container, for heating the cryogenic medium; a second or internal or in-tank heat exchanger, fluidically connected to the gas removal line and arranged downstream of the first heat exchanger and inside the storage container, for heating the liquid medium in the storage container; a liquid removal line for removing the liquid medium from the storage container; a first controllable shut-off valve arranged in the gas removal line; and a second controllable shut-off valve arranged in the liquid removal line. Alternatively, instead of a first controllable shut-off valve and a second controllable shut-off valve, a controllable changeover valve can be configured with a first inlet at the gas removal line and a second inlet at the liquid removal line.

In accordance with one or more embodiments, the cryogenic medium can thus be removed from the storage container in two different ways, particularly, on the one hand through a liquid removal line, which in a normal operating state of the storage container extends into the liquid medium, and on the other hand through a second, gas removal line which is different from the liquid removal line and which in a normal operating state of the storage container extends into the gaseous medium. Because the gaseous medium is located above the liquid medium in the storage container, the inlet of the liquid removal line is preferably located in the vicinity of a base of the storage container and the gas removal line is preferably located in the vicinity of a roof of the storage container. Each of the two separate removal lines has its own associated shut-off valve, so that, depending on the position of the two shut-off valves, medium can be removed either only through the liquid removal line or only through the gas removal line, or preferably also through both lines.

Alternatively, a controllable changeover valve can be configured with a first inlet at the gas removal line and a second inlet at the liquid removal line, so that likewise, depending on the position of the changeover valve, medium can be removed either only through the liquid removal line or only through the gas removal line. Liquid or gaseous medium can then be removed with a single changeover valve. Such a changeover valve, preferably having two inlets and one outlet, can open either the “liquid” inlet or the “gaseous” inlet and preferably also have the additional function of blocking both inlets or the outlet.

The medium removed from the storage container is heated by a first heat exchanger and the heated medium is fed to a consumer, for example to a fuel cell.

After the first heat exchanger, all the heated medium flows through the storage container again, namely through an in-tank heat exchanger arranged inside the storage container for heating the liquid medium in the storage container. The in-tank heat exchanger is for this purpose preferably arranged in a region of the storage container in which liquid medium is usually located in the storage container, i.e., preferably in the vicinity of the base of the storage container.

By purposively opening or closing the first and/or second shut-off valve, or the first inlet and/or the second inlet of the changeover valve, removal of the medium can take place only through the liquid removal line or only through the gas removal line or through both lines, i.e., in liquid form or in gaseous form or in both states simultaneously.

When gas is removed from the storage container, there is a drop in pressure in the storage container. This can happen, in particular, when the storage container is at or close to the upper limit of the working pressure (MAWP, maximum allowable working pressure).

When liquid is removed from the storage container, there is an increase in pressure in the storage container. This can happen in particular, when the storage container is at or close to the lower limit of the working pressure (NWP, nominal working pressure).

By controlling the first shut-off valve and the second shut-off valve, or the changeover valve, the pressure in the storage container can accordingly be regulated upon removal of the medium. A controllable three-way valve, or partial-stream valve, for returning only a portion of the removed medium to the in-tank heat exchanger is thereby not required for pressure control. The storage system can therefore be constructed more simply and produced more inexpensively than other known storage systems.

In accordance with one or more embodiments, the in-tank heat exchanger is preferably so dimensioned that the pressure in the storage container falls when gas is removed via the gas removal line, despite vaporization at the in-tank heat exchanger, and that the pressure in the storage container rises when liquid is removed via the liquid removal line, at least due to vaporization at the in-tank heat exchanger.

In accordance with one or more embodiments, there is preferably no controllable three-way valve arranged in the gas removal line or in the liquid removal line, at least downstream of the first heat exchanger, so that all the medium removed through the gas removal line and/or through the liquid removal line and heated by the first heat exchanger reaches the in-tank heat exchanger.

There is particularly preferably no controllable three-way valve arranged in the gas removal line or in the liquid removal line, so that all the medium removed through the gas removal line and/or through the liquid removal line reaches the in-tank heat exchanger.

The storage system preferably comprises a control unit configured to control the pressure in the storage container upon removal of the medium in that the control unit opens either the first shut-off valve or the second shut-off valve, or opens the first inlet or the second inlet of the changeover valve, so that the medium is removed from the storage container either via the gas removal line or via the liquid removal line. The control unit can preferably also simultaneously open or simultaneously close the first shut-off valve and the second shut-off valve, or the first inlet and the second inlet of the changeover valve.

The storage system preferably comprises a double-walled container for receiving the medium, the storage container forming the inner container of the double-walled container and the double-walled container additionally comprising an outer container which surrounds the storage container.

The first heat exchanger is preferably arranged between the storage container forming the inner container and the outer container. Alternatively, the first heat exchanger can be arranged outside the outer container. The same, first heat exchanger is preferably fluidically connected both to the gas removal line and to the liquid removal line. The first shut-off valve and the second shut-off valve are preferably arranged upstream of the first heat exchanger.

A second heat exchanger for heating the medium is preferably arranged downstream of the in-tank heat exchanger and outside the storage container.

When the storage system comprises a double-walled container for receiving the medium, the storage container forming the inner container of the double-walled container and the double-walled container additionally comprising an outer container which surrounds the storage container, the second heat exchanger is preferably arranged between the storage container forming the inner container and the outer container. Alternatively, the second heat exchanger can also be arranged outside the outer container.

As described here for the second heat exchanger, other components of the storage system, in particular, other components that are relevant for controlling the storage system, such as, for example, the first and second shut-off valve, non-return valve etc., can preferably be arranged between the inner container, i.e., the storage container, and the outer container, i.e., preferably in a vacuum space. Alternatively, these components can also be arranged outside the outer container.

The first heat exchanger and the second heat exchanger can be designed as two separate heat exchangers or as a common heat exchanger with two separate channels for the cryogenic medium and a common channel for the heat transfer medium.

The medium removed via the gas removal line and/or the liquid removal line is preferably fed downstream of the in-tank heat exchanger to a consumer, in particular to a fuel cell. The medium that has been removed preferably reaches the consumer after the second heat exchanger.

A third shut-off valve is preferably arranged after the in-tank heat exchanger and before the consumer. The third shut-off valve can be arranged in particular in the flow path after the second heat exchanger.

### DRAWINGS

One or more embodiments will be illustrated by way of example in the drawings and explained in the description hereinbelow.

FIG. 1 illustrates a schematic illustration of a storage system, in accordance with one or more embodiments.

FIG. 2 illustrates a schematic illustration of a storage system, in accordance with one or more embodiments.

### DESCRIPTION

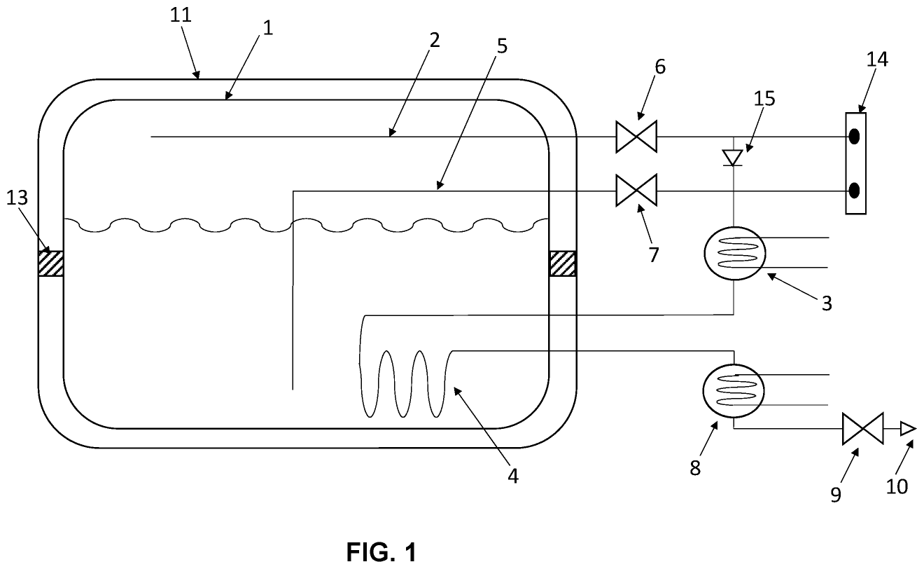

FIG. 1 illustrates a storage system for storing a cryogenic medium such as hydrogen, in accordance with one or more embodiments. The storage system comprises a storage container 1 for receiving the medium. The storage container 1 forms an inner container of a double-walled container, which additionally comprises an outer container 11. A vacuum is formed between the outer container 11 and the inner container, i.e., the storage container 1. Mountings 13 are additionally arranged in some regions between the outer container 11 and the inner container, in order to position the two shells of the double-walled container relative to one another.

In the lower region of the storage container 1, namely below the liquid surface, which is shown as a wavy line in FIG. 1, the cryogenic medium, in particular, hydrogen, is present in the container in the form of a liquid, above the wavy liquid surface it is present in the gaseous state.

A gas removal line 2 is adapted to remove the gaseous medium from the storage container 1, so that the free end of the gas removal line 2 ends in the storage container 1 above the liquid surface, in the vicinity of the roof of the storage container 1.

A liquid removal line 5 is adapted to remove the liquid medium from the storage container 1, so that the free end of the liquid removal line 5 ends in the storage container 1 below the liquid surface, in the vicinity of the base of the storage container 1. The terms “roof” and “base” thereby refer to the usual installation position of the storage container, for example in a driving or flying transport device, gravity acting in the direction towards the bottom of the storage container in normal operation of the transport device.

A first controllable shut-off valve 6 is arranged in the gas removal line 2, and a second controllable shut-off valve 7 is arranged in the liquid removal line 5. Both shut-off valves are located outside the storage container 1. In FIG. 1, the shut-off valves are also located outside the outer container 11.

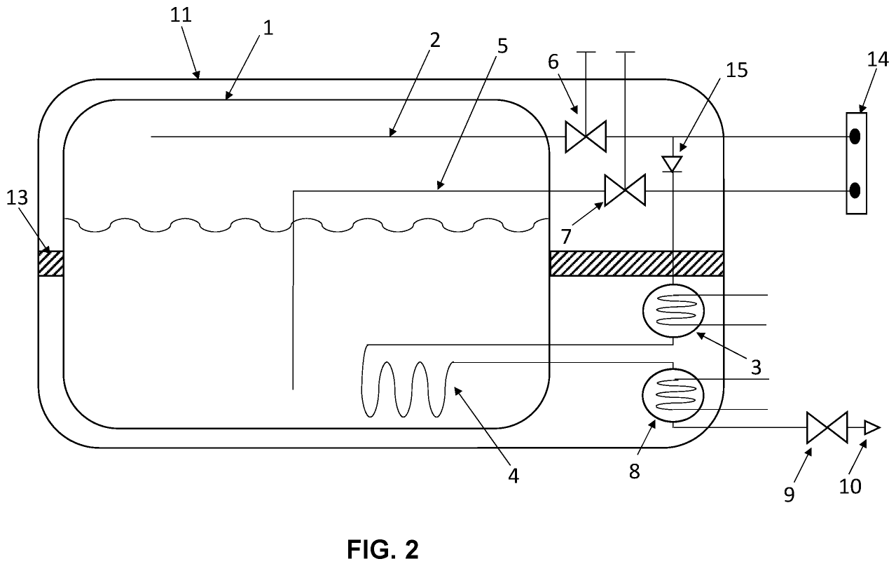

As illustrated FIG. 2, in an alternative embodiment of the storage system, the two shut-off valves are arranged inside the outer container 11, i.e., between the inner container, the storage container 1, and the outer container of the double-walled storage container, in particular, in the vacuum space.

The shut-off valves are controllable by a control device, which is likewise arranged in the vacuum space (FIG. 2) or outside the container as a whole (FIG. 1). The flow through the shut-off valves can thereby preferably not only be interrupted or enabled but also reduced.

Refueling of the storage container 1 from a refueling device 14 can also take place via the gas removal line 2 and/or the liquid removal line 5, preferably also via the first shut-off valve 6 and/or the second shut-off valve 7.

The gas removal line 2 and the liquid removal line 5 are brought together after the two shut-off valves 6, 7 to form a common line. A rectifying valve, in particular, a non-return valve 15, can be arranged in the gas removal line 2, so that only the direction of flow from the first shut-off valve 6 to the first heat exchanger 3 is permitted, the opposite direction is blocked.

The gas removal line 2 and the liquid removal line 5, in the form of the common line, are fluidically connected to the first heat exchanger 3, which is arranged outside the storage container 1, for example, between the storage container 1 and the outer container 11 of the double-walled storage container (FIG. 2), for heating the medium which has been removed.

An in-tank heat exchanger 4 for heating the liquid medium in the storage container 1 is arranged downstream of the first heat exchanger 3 inside the storage container 1, the heated medium removed from the storage container 1 flowing through the in-tank heat exchanger. As a result of heating at the in-tank heat exchanger 4, the liquid medium in the storage container 1 is partially heated and vaporized.

There is no controllable three-way valve arranged in the gas removal line 2 or in the liquid removal line 5, so that all the medium removed through the gas removal line 2 and/or through the liquid removal line 5 and heated by the first heat exchanger 3 reaches the in-tank heat exchanger 4.

Since the pressure in the storage container 1 is regulated via the first and second shut-off valve 6, 7, a controllable three-way valve is not required.

A control unit of the storage system is adapted to control the pressure in the storage container 1 upon removal of the medium in that the control unit opens either the first shut-off valve 6 and/or the second shut-off valve 7, so that the medium is removed from the storage container 1 either via the gas removal line 2 and/or via the liquid removal line 5.

A second heat exchanger 8 for heating the medium is arranged downstream of the in-tank heat exchanger 4 and outside the storage container 1, outside (FIG. 1) or inside (FIG. 2) the outer container 11 of the double-walled container.

The medium removed via the gas removal line 2 and/or the liquid removal line 5 is fed downstream of the in-tank heat exchanger 4 to a consumer 10, in particular to a fuel cell. A third shut-off valve 9 is arranged between the second heat exchanger 8 and the consumer 10.

The embodiment of FIG. 2 differs from FIG. 1 in that components of the storage system that are relevant for control, such as the first heat exchanger 3, the second heat exchanger 8, the first shut-off valve 6 and the second shut-off valve 7, and also the non-return valve 15, are arranged inside the outer container 11, not outside the outer container 11 as in FIG. 1, and are thus arranged in the intermediate space of the double-walled container, which forms a vacuum space.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 storage container
2 gas removal line
3 first heat exchanger
4 in-tank heat exchanger
5 liquid removal line
6 first controllable shut-off valve
7 second controllable shut-off valve
8 second heat exchanger
9 third controllable shut-off valve
10 consumer
11 outer container
13 mounting
14 refueling device
15 non-return valve

What is claimed is:

1. A storage system for storing a cryogenic medium, the storage system comprising:
a storage container for receiving the cryogenic medium;
a gas removal line for removing gaseous cryogenic medium from the storage container;
a first heat exchanger, fluidically connected to the gas removal line and arranged outside of the storage container, for heating the cryogenic medium;
a second heat exchanger, fluidically connected to the gas removal line and arranged downstream of the first heat exchanger and inside the storage container, for heating liquid cryogenic medium in the storage container;
a liquid removal line for removing the liquid cryogenic medium from the storage container;
a controllable first shut-off valve arranged in the gas removal line; and
a controllable second shut-off valve arranged in the liquid removal line.

2. The storage system of claim 1, wherein there is no controllable three-way valve arranged in the gas removal line or in the liquid removal line, at least downstream of the first heat exchanger, so that all the cryogenic medium removed through the gas removal line and/or through the liquid removal line and heated by the first heat exchanger reaches the second heat exchanger.

3. The storage system of claim 1, further comprising a control unit, operatively connected to the first shut-off valve and/or the second shut-off valve, to control the pressure in the storage container upon removal of the cryogenic medium.

4. The storage system of claim 1, wherein the control unit opens the first shut-off valve and/or the second shut-off valve, so that the medium is removed from the storage container either via the gas removal line and/or via the liquid removal line.

5. The storage system of claim 1, wherein the storage container comprises a double-walled storage container for receiving the cryogenic medium that includes an inner container and an outer container which surrounds the inner container.

6. The storage system of claim 5, wherein the first heat exchanger is arranged between the inner container and the outer container.

7. The storage system of claim 5, wherein the first heat exchanger is arranged outside of the outer container.

8. The storage system of claim 1, wherein the first heat exchanger is fluidically connected to the gas removal line and the liquid removal line.

9. The storage system of claim 8, wherein the first shut-off valve and the second shut-off valve are arranged upstream of the first heat exchanger.

10. The storage system of claim 1, wherein the cryogenic medium removed via the gas removal line and/or the liquid removal line is fed downstream of the second heat exchanger to a fuel cell.

11. A storage system for storing a cryogenic medium, the storage system comprising:
a storage container for receiving the cryogenic medium, the storage container including an inner container and an outer container which surrounds the inner container to form a double-walled container;
a gas removal line for removing gaseous cryogenic medium from the storage container;
a first heat exchanger, fluidically connected to the gas removal line and arranged outside of the storage container, for heating the cryogenic medium;
a second heat exchanger, fluidically connected to the gas removal line and arranged downstream of the first heat exchanger and inside the storage container, for heating liquid cryogenic medium in the storage container;
a third heat exchanger, for heating the cryogenic medium, arranged downstream of the second heat exchanger and outside the storage container;
a liquid removal line for removing the liquid cryogenic medium from the storage container;
a first controllable shut-off valve arranged in the gas removal line; and
a second controllable shut-off valve arranged in the liquid removal line.

12. The storage system of claim 11, wherein the second heat exchanger is arranged between the inner container and the outer container.

13. The storage system of claim 11, wherein the second heat exchanger is arranged outside of the outer container.

14. The storage system of claim 11, further comprising a control unit, operatively connected to the first shut-off valve and/or the second shut-off valve, to control the pressure in the storage container upon removal of the cryogenic medium.

15. A storage system for storing a cryogenic medium, the storage system comprising:
a storage container for receiving the cryogenic medium;
a gas removal line for removing gaseous cryogenic medium from the storage container;
a first heat exchanger, fluidically connected to the gas removal line and arranged outside of the storage container, for heating the cryogenic medium;
a second heat exchanger, fluidically connected to the gas removal line and arranged downstream of the first heat exchanger and inside the storage container, for heating liquid cryogenic medium in the storage container;
a liquid removal line for removing the liquid cryogenic medium from the storage container; and
a controllable changeover valve having a first inlet at the gas removal line and a second inlet at the liquid removal line.

16. The storage system of claim 15, wherein there is no controllable three-way valve arranged in the gas removal line or in the liquid removal line, at least downstream of the first heat exchanger, so that all the cryogenic medium removed through the gas removal line and/or through the liquid removal line and heated by the first heat exchanger reaches the second heat exchanger.

17. The storage system of claim 15, further comprising a control unit, operatively connected to the first shut-off valve and/or the second shut-off valve, to control the pressure in the storage container upon removal of the cryogenic medium.

18. The storage system of claim 17, wherein the control unit opens the first inlet and/or the second inlet of the changeover valve, so that the medium is removed from the storage container either via the gas removal line and/or via the liquid removal line.

19. The storage system of claim 15, wherein the first heat exchanger is fluidically connected to the gas removal line and the liquid removal line.

20. The storage system of claim 19, wherein the changeover valve is arranged upstream of the first heat exchanger.
